(19) United States
(12) Patent Application Publication
(10) Pub. No.: US 2004/0217691 A1
(43) Pub. Date: Nov. 4, 2004

(54) Metallized plastic molded part

(76) Inventors: Gerhard Opelka, Leverkusen (DE); Eckard Foltin, Sinzig (DE); Georgios Tziovaras, Wuppertal (DE); Roland Kunzel, Leverkusen (DE)

Correspondence Address: BAYER MATERIAL SCIENCE LLC, 100 BAYER ROAD, PITTSBURGH, PA, 15205, US

(21) Appl. No.: 10/832,070

(22) Filed: Apr. 26, 2004

(30) Foreign Application Priority Data
Apr. 30, 2003 (DE) 10319392.8

(51) Int. Cl. H05B 33/14; H05B 33/26

(52) U.S. Cl. 313/503; 313/502; 313/506

(57) ABSTRACT

A layered article, the structure of which comprises a layer of a transparent thermoplastic material, a metallic layer having a thickness of 5 to 250 nm, and an electroluminescent layer containing one or more lectroluminescent compounds is disclosed. The article is useful in transmitted light technology.

### FIELD OF THE INVENTION

The invention is directed to a plastic-molded article and specifically to a metallized article metallized.

### SUMMARY OF THE INVENTION

A layered article, the structure of which comprises a layer of a transparent thermoplastic material, a metallic layer having a thickness of 5 to 250 nm, and an electroluminescent layer containing one or more electroluminescent compounds is disclosed. The article is useful in transmitted light technology.

### BACKGROUND OF THE INVENTION

Plastic molded parts which have a metallic lustre in addition to a decorative layer are produced, for example, by chemical-electrolytic metallization of molded parts made of a thermoplastic material, e.g. acrylonitrile-butadiene-styrene (ABS), polyamide (PA). The thickness of the applied metal layer is of the order of magnitude of a few μm, which means that the metal layer is not transparent and cannot be after its application be shaped. Transmitted light technology cannot be used with these molded parts due to the lack of transparency.

Plastic molded parts are also known which are produced by vapor deposition of the metal layer in a high vacuum, using physical vapor deposition (PVD) or chemical vapor deposition (CVD), for example. Although these metal layers, with a thickness of the order of magnitude of a few nanometers (nm), make these parts suitable for use in applications entailing transmitted light technology, this is achieved only with the aid of additional lights such as light-emitting diodes or incandescent lamps. Additional structural space is required for mounting these lights. In addition these lights produce a considerable amount of heat during operation.

On the other hand, plastic molded parts with an electroluminescent layer on a transparent film of thermoplastic material, e.g. polyethylene terephthalate (PET) have been disclosed. Indium-tin oxide (ITO) is used as a transparent electrode in this case. Although these plastic films exhibit a homogeneous light through an area without producing heat, the films made of PET are not suitable as decorative films in the process of In-Mold-Decorative (IMD), a process known also as Film Insert Molding (FIM). These molded parts do not have a metallic lustrous surface.

### BRIEF DESCRIPTION OF THE DRAWINGS

FIG. 1 shows an embodiment of the inventive layered structure.

### DETAILED DESCRIPTION OF THE INVENTION

The object of the present invention is to provide a three-dimensional metallized plastic molded part with areal lighting. The plastic molded parts needs to be capable of being shaped and of being used in the MD (FIM) process in which it needs to withstand the application of molten thermoplastic resin thereon (herein back-sprayed). In the case of adequate brightness, e.g. in daylight, the metallic lustrous effect should be apparent whereas in darkness the lighting effect of an electroluminescent compound should penetrate through the metallic layer.

The invention provides a metallized plastic molded part which has at least the following layer structure:

at least one layer of a transparent thermoplastic material

at least one layer of metal having a thickness of 5 to 250 nm

at least one layer containing one or more electroluminescent compounds.

The metallic layer having a thickness of 5 to 250 nm, preferably 15 to 60 nm, on the one hand provides the plastic molded part with a metallic lustre, and on the other hand is transparent. Thus, transmitted light effects may be used with the plastic molded part according to the invention. In addition, the metal layer also serves as the electrical contact for the electroluminescent layer.

Preferred metals have a high electrical conductivity and metallic lustre. Chromium, titanium, molybdenum, aluminium, copper, gold, iridium and indium are used as preferred metals.

The metal layer may be applied to the thermoplastic material using, for example, physical vapor deposition (PVD) or chemical vapor deposition (CVD) or a combination of these processes.

The layer of a transparent thermoplastic material preferably has a thickness of 50 to 3000 μm, preferably 175 to 750 μm. The plastic layer is optionally decorated and/or colored.

Preferred thermoplastic materials include polycarbonate (PC), polyethylene terephthalate (PET), styrene-acrylonitrile (SAN), acrylonitrile-ethylene-propylenediene-styrene (AES), acrylonitrile-styrene-acrylate (ASA), acrylonitrile-butadiene-styrene (ABS), polymethylmethacrylate (PMMA), polystyrene (PS), polyamide (PA), in particular PA 11, PA 12, cycloolefin copolymers (COC), cellulose esters, thermoplastic polyurethane (TPU), thermoplastic elastomers (TPE).

The transparent thermoplastic material layer may be colored and/or decorated. It may be shaped before or after application of the metal layer, e.g. by high-pressure forming or thermoforming.

The light transmission of the combination of metal layer with the thermoplastic material layer is more than 20 % in the visible wavelength region from 400 to 700 nm (100 % means complete light transmission [no loss of light]).

Zinc sulfide which is doped with silver or copper may be used as an electroluminescent compound. These types of electroluminescent compounds are commercially available, e.g. from Lumitec AG, Switzerland.

The electroluminescent layer is applied to at least a portion of the surface area of the metallized thermoplastic material for example in accordance with a certain pattern, e.g. by the silk-screening process.

The layer of metal and the layer of one or more electroluminescent compounds (herein the electroluminescent layer) preferably have one electrical contact each.

In a preferred embodiment, at least one additional layer of one or more electrically conductive plastics is positioned between the layer of metal and the electroluminescent layer. This layer of an electrically conductive plastic takes on or reinforces the function of the electrical contact of the metal layer and improves the forming characteristics.

The thickness of the layer of electrically conductive plastic is preferably 1 to 20 μm. Examples of electrically conductive plastics which may be used in the structure of the plastic molded part according to the invention are: poly-3,4-ethylenedioxythiophene (PEDOT), polyaniline, electrically conductive lacquer systems. They are characterized by high light transmission, in particular 70 to 95 %, along with good electrical conductivity, preferably with a specific electrical resistance less than 10⁴Ω·cm.

In addition, at least one layer of a transparent plastic material, e.g. polycarbonate and/or a transparent lacquer may also be introduced between the metallized layer and the electroluminescent layer in order to maintain the full lustrous effect of the metal layer.

There again, a protective layer of a thermoplastic material and/or an adhesive and/or a lacquer may optionally also be applied to the electroluminescent layer. The thermoplastic material may be back-sprayed. The protective layer is positioned on the face of the electroluminescent layer away from the metallic layer.

The following thermoplastic materials are preferably used for back-spraying the protective layer: thermoplastic materials which are not filled or are provided with reinforcing substances and/or fillers such as polycarbonate, acrylonitrile-butadiene-styrene (ABS), styrene-acrylonitrile (SAN), polybutylene terephthalate (PBT), polyamide (PA), thermoplastic polyurethane (TPU), polyethylene terephthalate (PET), polystyrene (PS), polyoxymethylene (POM), polyolefins, e.g. polyethylene (PE), polypropylene (PP), polyesters, polymethylmethacrylate (PMMA), elastomer-deficient blends, thermoplastic PVC or mixtures of such thermoplastic materials.

A solvent-free adhesive based on polyurethane (PUR), in particular single-component PUR, may be used as an adhesive. Lacquers are liquid, pasty or powdered coating substances which produce an opaque coating with protective, decorative, etc. properties.

As a protective layer for the metallized plastic molded part according to the invention, lacquer systems, for example those based on high temperature resistant plastics, e.g. PC, HT-PC, polyethylene terephthalate (PET) or polybutylene terephthalate (PBT), or polyurethane lacquer systems or Noriphan® (a solution of synthetic plastic resins in organic solvents, from Pröll, Germany), may be used.

The protective layer protects the metal layer and the electroluminescent layer against mechanical and/or chemical effects and improves the adhesive properties of the support element.

The metallized plastic part according to the invention may be mounted on a support element. The support element may be, for example, a molded part of a thermoplastic material, e.g. PUR. It may be used, for example, for reinforcing or mounting purposes or as a structural element. It is applied, for example, in an injection molding process or with the aid of an adhesive. In this case, the protective layer takes on another function: it prevents washing-out when injecting the plastic, this occurring as a result of the relatively elevated temperatures of greater than 180 ° C. and high pressures of greater than 200 bar.

An advantage of the invention is that the metallic lustre of a metallized plastic molded part is combined with areal lighting. As a result of the areal lighting, which is due to the use of electroluminescent compounds, complex three-dimensional geometries may be made to glow uniformly. When the electroluminescent layer produces light, no heat is produced. Since no additional lights requiring accommodating space have to be used, very slim metallized plastic molded parts may be produced. In addition, it is an advantage that the final molded part may be shaped, for example using high pressure forming in accordance with EP O 371 425, after the several layers have been applied one to the other. Furthermore, the layered structure of the metallized plastic molded part according to the invention forms an isolated, water-tight system.

The metallized plastic molded part according to the invention may be used, for example, in motor vehicles applications.

The invention is explained in more detail in the following, reference being made to the attached drawing.

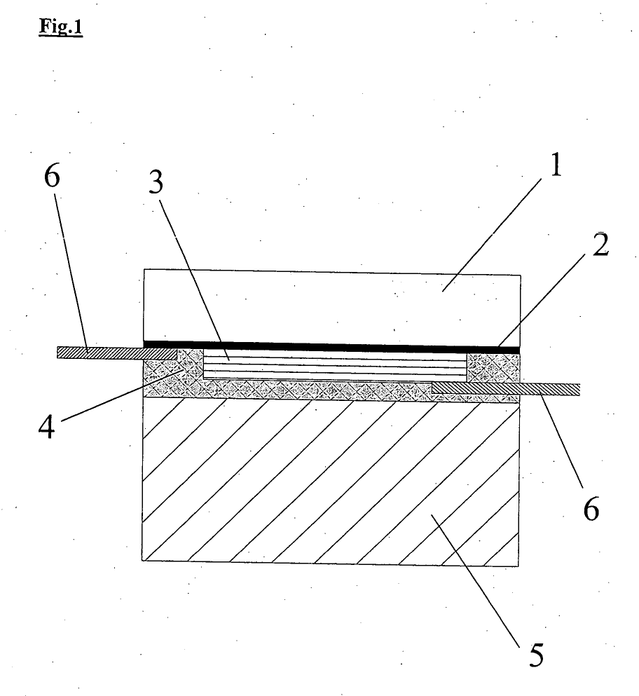

FIG. 1 shows a preferred layered structure for the metallized plastic molded part according to the invention. One face of a film of thermoplastic material 1 is provided with a thin metal layer 2 which is transparent. A layer of one or more electroluminescent compounds 3 is applied to the metallic layer. The metal layer 2 on the one hand and the electroluminescent layer 3 on the other hand are provided with an electrical contact, 6 and 6′ respectively. The electroluminescent layer 3 is provided with a protective layer 4. If the electroluminescent layer is not applied to the entire area, but only to parts, in the form of a pattern, as shown in FIG. 1, then the protective layer 4 covers the metallic layer 2 in the regions where the metallic layer is not provided with an electroluminescent layer 3. Apart from protecting the electroluminescent layer 3, the protective layer 4 thus also compensates for the different thicknesses of the plastic molded part. Finally, this metallized plastic molded part, built up in layers, is mounted on a support element 5.

### EXAMPLES Example 1.

A transparent PC film (Makrofol®, Bayer AG, Germany) with a thickness of 250 μm was provided with a 50 nm thick layer of chromium, using plasma-supported volume coating, and then partly covered with a layer of an electroluminescent compound (EL layer) from Lumitec AG (Switzerland). Electrical contact was made via contact tabs which were bonded, with conductive adhesives, to the chromium layer on the one hand and to the EL layer on the other hand.

### Example 2

The transparent PC film (Makrofol®, Bayer AG, Germany) with a thickness of 250 μm was provided with a 50 nm thick layer of chromium, using plasma-supported volume coating. A 50 μm thick layer of a transparent PC film was applied to the chromium layer. An EL layer was applied to parts of the PC film. The metallized plastic molded part produced in this way could be shaped, stamped out and back-sprayed. Electrical contact was made directly with the EL layer. For electrical contact purposes, channels were introduced in the plastic layer, with the aid of knock-out pins in the injection mold, during back-spraying of the metallized plastic molded part with a thermoplastic material. Springs on the glued-on inverter were used to make good electrical contact between the inverter and the plastic molded part. The inverter transforms the voltage from 9V (direct current) to 110V (alternating current) which is applied at the EL-layer in order to emit the light. The springs are conductive contacts from the inverter to the EL-electrodes.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A layered article the structure of which comprise
a layer of a transparent thermoplastic material,
a metallic layer having a thickness of 5 to 250 nm, and
an electroluminescent layer containing one or more electroluminescent compounds.

2. The article of claim 1, wherein metallic layer has a thickness of 15 to 60 nm.

3. The article of claim 1 wherein the metallic layer contains at least one member selected from the group consisting of chromium, titanium, molybdenum, aluminium, copper, gold, indium and iridium.

4. The article of claim 1 wherein the transparent thermoplastic material has a thickness of 50 to 3000 μm.

5. The article of claim 1 wherein the metallic layer and the electroluminescent layer each includes at least one electrical contact.

6. The article of claim 1 further comprising at least one member selected from the group consisting of a protective layer an adhesive and a lacquer applied to the electroluminescent layer.

7. The article of claim 1 further comprising at least one layer containing at least one electrically conductive plastic positioned between the metallic layer and the electroluminescent layer.

8. The article of claim 1 further comprising at least one member selected from the group consisting of a layer of transparent plastic and a transparent lacquer, positioned between the metallic layer and electroluminescent layer.
